(19) United States
(12) Patent Application Publication
(10) Pub. No.: US 2009/0147011 A1
(43) Pub. Date: Jun. 11, 2009

(54) Method and system for graphically indicating multiple data values

(75) Inventors: Schuyler Buck, Muncie, IN (US); Morris J. Young, Indianapolis, IN (US); Jason Bush, Fishers, IN (US); Christopher Richard Baker, Fishers, IN (US); Scott W. Leahy, Fort Wayne, IN (US)

Correspondence Address: BAKER & DANIELS LLP / ROCHE, 300 NORTH MERIDIAN STREET, SUITE 2700, INDIANAPOLIS, IN, 46204, US

(73) Assignees: Roche Diagnostics Operations, Inc., Indianapolis, IN (US); Logikos, Inc.

(21) Appl. No.: 11/999,853

(22) Filed: Dec. 7, 2007

(51) Int. Cl. G06F 15/00

(52) U.S. Cl. 345/501

(57) ABSTRACT

A system and method for displaying data are disclosed, the method being applicable to a system comprising a computing device having an output device and computer programs, and, optionally, an input device. The programs are configured to show point display objects and group display objects corresponding to data points located near each other. The group display objects are distinguishable from the point display objects.

### FIELD OF THE INVENTION

The invention relates a method and system for displaying information on an output device. More particularly, the invention relates a method and system for graphically displaying multiple data values.

### BACKGROUND OF THE INVENTION

Many fields of medical treatment and healthcare require monitoring of certain physiological parameters. Technological advancements in medicine led to the increased use of medical devices, e.g., meters and infusion pumps, to collect medical data, and of healthcare data management systems. Healthcare data management methods and systems traditionally developed for use in healthcare facilities and health management organizations are increasingly used by patients, care givers, and others. U.S. Pat. No. 7,103,578 and U.S. Published Application No. 2004/0172284 disclose two such methods and systems. Some healthcare data management systems are able to transfer data between them.

A common feature of healthcare data management systems is the ability to convey information. Information can include raw data, graphical representations of data such as statistical display objects, explanations and textual interpretations, inferential information and so on. Communication and understanding can be improved by using interactive graphs to convey information. In one particular embodiment, the development of graphical user interfaces (GUI) facilitates user interaction with data processing and other software applications. In a typical embodiment, a GUI can display a number of display objects that are individually manipulable by a user utilizing a user input device. For example, the user can utilize a computer keyboard, mouse, touch screen, touch pad, roller ball or voice commands and the like to select a particular display object and to further initiate an action corresponding to the selected display object.

In one particular embodiment, computer programs may utilize a screen pointer icon to facilitate the selection of the display object with the user input device. In another particular embodiment, programs may utilize a display template for displaying a number of display objects within a graphical view window corresponding to a particular software application to utilize functionality provided by the software application. For example, many programs utilize display templates that correspond to graphs in which individual display objects are represented in relation to scaled axes.

Users interact with display objects by using user input devices to register control inputs. In this regard, a single input refers to the selection of a control, such as pressing of a mouse control button, touch pad control button, or the tapping of a touch sensitive screen interface a single time within a short period of time or the pressing of a key on a keyboard assigned to register a single input (e.g., space bar). Similarly, a double input refers to the selection of a control two successive times within the same short period of time or the pressing of a key on a keyboard assigned to register a double input (e.g., enter). Mouseover refers to the placement of a screen pointer over a display object. Hover refers to a mouseover that lasts at least a predefined length of time. The action of generating these control inputs is well known in the art, and will not be described in any further detail. The generation of a control input on a display object results in a modification of an attribute of the display object and/or the initiation of one or more actions by the software application.

In one embodiment of an interactive method to convey information, a tooltip is used to display information. A tooltip is a display object typically displayed on mouseover, or hover, to provide additional information to the user. In one embodiment, the tooltip displays predefined text relating to a display object for the purpose of describing the display object.

### SUMMARY OF THE INVENTION

A system and method for displaying data is provided. The system comprises a computing device and computer programs. The method may be implemented in the computing device. The computing device contains data, and has an output device, and may comprise one or more input devices for registering user inputs. The programs generate screen displays incorporating display objects and can process a variety of user inputs. Display objects can be activated by registration of user inputs corresponding to display objects to cause performance of some action within the computing device. The display objects represent data which may be categorized in various ways. A program compares data points and identifies groups of data points located near to each other (“near points”) according to predefined or interactively determined criteria.

In accordance with an aspect of the present invention, a method for displaying information in a screen display presented on the output device is provided. In accordance with the method, a program identifies groups of near points and provides at least one group display object to the screen display. The group display object is visually distinguishable from point display objects representative of near points in the group.

In accordance with another aspect of the present invention, a method for displaying information in a screen display presented on the output device is provided. In accordance with the method, the screen display has group display objects. A program merges tooltips associated with each near point in the group, and it displays a merged tooltip upon activation of a group display object.

Furthermore, a method for displaying information in a screen display which combines the first and second aspects of the invention is provided.

In accordance with a further aspect of the present invention, a method for displaying information in a screen display presented on the output device is provided. A program creates interactive tooltips. Upon activation of the interactive tooltip, the program provides user options and performs a function according to the option selected by the user. For example, one option may be to display additional tooltips.

In accordance with another aspect of the present invention, a method for displaying information in a screen display presented on the output device is provided. In one embodiment, the user interactively selects a subset of data points, and a program displays display objects corresponding to the selected points.

### DESCRIPTION OF THE DRAWINGS

The foregoing aspects of this invention will become more readily appreciated as the same become better understood by reference to the following detailed description when taken in conjunction with the accompanying drawings.

FIG. 1 is a conceptual diagram of a system according to the invention comprising a medical device and a computing device having a modulated signal transceiver.

FIG. 2 is a screen display according to the invention depicting display objects including point markers, and group markers.

FIG. 3 is a graph portion of a screen display according to the invention depicting display objects including point markers, group markers, and a merged tooltip.

FIG. 4 is a graph portion of a screen display according to the invention depicting display objects including point markers, group markers, and a merged tooltip; and a group marker shaped like a number.

FIG. 5 is a graph portion of a screen display according to the invention depicting display objects including point markers, group markers, and an interactive tooltip.

FIG. 6 is a graph portion of a screen display according to the invention depicting display objects including point markers, group markers, and two merged tooltips.

FIG. 7 is a graph portion of a screen display according to the invention depicting a scatter graph having display objects including point markers, a group marker and a merged tooltip.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

Concepts described below may be further explained in one of more of the co-filed patent applications entitled HELP UTILITY FUNCTIONALITY AND ARCHITECTURE (Atty. Docket: ROCHE-P0033), SYSTEM AND METHOD FOR DATABASE INTEGRITY CHECKING (Atty. Docket: ROCHE-P0056), METHOD AND SYSTEM FOR DATA SOURCE AND MODIFICATION TRACKING (Atty. Docket: ROCHE-P0037), PATIENT-CENTRIC HEALTHCARE INFORMATION MAINTENANCE (Atty. Docket: ROCHE-P0043), EXPORT FILE FORMAT WITH MANIFEST FOR ENHANCED DATA TRANSFER (Atty. Docket: ROCHE-P0044), GRAPHIC ZOOM FUNCTIONALITY FOR A CUSTOM REPORT (Atty. Docket: ROCHE-P0048), METHOD AND SYSTEM FOR SELECTIVE MERGING OF PATIENT DATA (Atty. Docket: ROCHE-P0065), METHOD AND SYSTEM FOR PERSONAL MEDICAL DATA DATABASE MERGING (Atty. Docket: ROCHE-P0066), METHOD AND SYSTEM FOR WIRELESS DEVICE COMMUNICATION (Atty. Docket: ROCHE-P0034), METHOD AND SYSTEM FOR SETTING TIME BLOCKS (Atty. Docket: ROCHE-P0054), METHOD AND SYSTEM FOR ENHANCED DATA TRANSFER (Atty. Docket: ROCHE-P0042), COMMON EXTENSIBLE DATA EXCHANGE FORMAT (Atty. Docket: ROCHE-P0036), METHOD OF CLONING SERVER INSTALLATION TO A NETWORK CLIENT (Atty. Docket: ROCHE-P0035), METHOD AND SYSTEM FOR QUERYING A DATABASE (Atty. Docket: ROCHE-P0049), METHOD AND SYSTEM FOR EVENT BASED DATA COMPARISON (Atty. Docket: ROCHE-P0050), DYNAMIC COMMUNICATION STACK (Atty. Docket: ROCHE-P0051), SYSTEM AND METHOD FOR REPORTING MEDICAL INFORMATION (Atty. Docket: ROCHE-P0045), METHOD AND SYSTEM FOR MERGING EXTENSIBLE DATA INTO A DATABASE USING GLOBALLY UNIQUE IDENTIFIERS (Atty. Docket: ROCHE-P0052), METHOD AND SYSTEM FOR ACTIVATING FEATURES AND FUNCTIONS OF A CONSOLIDATED SOFTWARE APPLICATION (Atty. Docket: ROCHE-P0057), METHOD AND SYSTEM FOR CONFIGURING A CONSOLIDATED SOFTWARE APPLICATION (Atty. Docket: ROCHE-P0058), METHOD AND SYSTEM FOR DATA SELECTION AND DISPLAY (Atty. Docket: ROCHE-P0011), METHOD AND SYSTEM FOR ASSOCIATING DATABASE CONTENT FOR SECURITY ENHANCEMENT (Atty. Docket: ROCHE-P0041), METHOD AND SYSTEM FOR CREATING REPORTS (Atty. Docket: ROCHE-P0046), METHOD AND SYSTEM FOR CREATING USER-DEFINED OUTPUTS (Atty. Docket: ROCHE-P0047), DATA DRIVEN COMMUNICATION PROTOCOL GRAMMAR (Atty. Docket: ROCHE-P0055), HEALTHCARE MANAGEMENT SYSTEM HAVING IMPROVED PRINTING OF DISPLAY SCREEN INFORMATION (Atty. Docket: ROCHE-P0031), METHOD AND SYSTEM FOR MULTI-DEVICE COMMUNICATION (Atty. Docket: ROCHE-P0064), and DEVICE AND METHOD FOR ASSESSING BLOOD GLUCOSE CONTROL (Atty. Docket: ROCHE-P0032), the entire disclosures of which are hereby expressly incorporated herein by reference. It should be understood that the concepts described below may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The present invention relates to a method and system for graphically indicating multiple data values. The system comprises a computer, applications, and databases. An application, computer program, or program, is here, and generally, conceived to be a sequence of computer instructions representing steps of methods for achieving desired results. The instructions are processed by a computer and require physical manipulations of physical quantities. Usually, though not necessarily, these quantities take the form of electrical or magnetic signals capable of being stored, transferred, combined, compared, and otherwise manipulated. Programs may use data structures for both inputting information and producing the desired result. Data structures impart a physical organization on the data stored in computer memory and greatly facilitate data management. Databases include data structures and data.

The actual physical implementation of a database on a general purpose computer may take several forms, from complete individual records storing the substantive information with several key indexes for locating a particular record, to a plurality of tables interrelated by relational operations, to a matrix of cross-linked data records, to various combinations and hybrids of these general types. In particular physical devices, a database may be structured and arranged to accommodate the restrictions of the physical device but, when transferred to a general purpose computer, be able to be stored in a variety of formats. Thus, while certain types of information may be described as being stored in a “database” from a conceptual standpoint, generally such information may be electronically stored in a variety of structures with a variety of encoding techniques.

Although the following description details operations in terms of a graphic user interface using display objects, the present invention may be practiced with text based interfaces, or even with voice or visually activated interfaces.

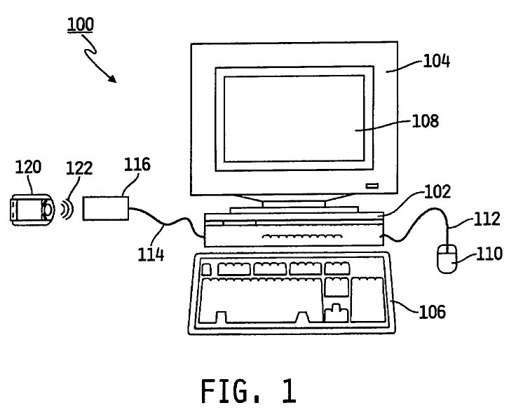

Turning now to the figures, FIG. 1 depicts an exemplary, embodiment of a system 100 according to the invention for managing data. While the invention is applicable to any system capable of managing data and downloading data from a portable device, the invention is described herein with reference to healthcare data management software, and more particularly, with reference to diabetes management software. The invention may also be applied in fields unrelated to healthcare management. A particular embodiment of system 100 is the ACCU-CHEK® 360° diabetes management system distributed by Roche Diagnostics Corporation. The ACCU-CHEK® 360° receives diabetes related data from a plurality of sources, allows users to modify data, and displays data in a plurality of formats and devices. To improve communication and understanding, the ACCU-CHEK® 360° allows users to choose when and how to display information. Users can choose from a plurality of graph formats, and can also choose how to graph data. Users can combine graphs, tables, and comments on the same screen display and can view the screen display on a computer screen or can print it. Methods for customizing the presentation of data on an output device are disclosed in the above-identified co-filed patent applications.

The system 100 comprises a computing device 102, shown here in the form of a computer having a display device 104, in this case a computer video screen or monitor having a screen 108, and a keyboard 106. The computing device 102 has a mouse 110 connected to it by a cable 112. While a mouse 110 and a keyboard 106 are shown, the system 100 may comprise any user input device. The system 100 includes software applications (not shown) configured to receive data from user input devices. Components of a computing device 102 also include, but are not limited to, a processing unit and system memory.

A screen display refers to pixel data used to present an image on an output device. Generally, an application writes images in the form of pixel data to a memory array or frame buffer and provides the frame buffer data to the output device for presentation. Raster scanning is the most common method of image transmission to an output device such as a screen 108. The number of pixels and the pixel size in a particular screen 108 is determined by its resolution and diagonal size and may vary according to the configuration of system 100. A 1024×768 resolution 19 inch screen has a pixel size of 0.377 mm. A 800×600 resolution 17 inch screen has a pixel size of 0.4318 mm. A 640×480 resolution 15 inch screen has a pixel size of 0.4763 mm. Similar processes are used to output pixel data of a screen display to other output devices.

Each display object has a placement control point used to locate the object on the screen display. The placement control might be in a center point, a corner, or any other point on the display object and it relates the display object to a point on the screen display, generally represented in terms of X-Y coordinates. In addition to the placement control point, each display object contains a bitmap image representing the shape, color, style, and other characteristics of the object.

The computing device 102 may include a variety of computer-readable media. Computer-readable media can be any available media that can be accessed by the computing device 102 and includes both volatile and non-volatile media, and removable and non-removable media. By way of example, and not limitation, computer-readable media may comprise computer storage media and communication media. The computer storage media provide storage of computer-readable instructions, software applications, data structures, program modules and other data for the computing device 102. A user may enter commands and data into the computing device 102 through a user input device such as a keyboard 106 and/or a mouse 110 or any other user input device. Other user input devices (not shown) may include a microphone, a joystick, a game pad, a satellite dish, a scanner, or the like. These and other input devices are often connected to the processing unit through a user input interface and may be connected by other interface and bus structures, such as a parallel port, game port or a universal serial bus (USB).

The computing device 102 may operate in a network environment using logical connections to one or more remote computers. The remote computer may be a personal computer, a server, a network PC, and typically includes many or all of the elements described above relative to computing device 102. The logical connections include a local area network (LAN) and a wide area network (WAN), but also include other networks. The terms “network,” “local area network,” “LAN,” “wide area network,” or “WAN” mean two or more computers which are connected in such a manner that messages may be transmitted between them. Such network environments are commonplace in office, enterprise-wide computer networks, Intranets, and the Internet. In such computer networks, typically one or more computers operate as a “server,” a computer with large storage media such as hard disk drives and communication hardware to operate peripheral devices such as printers or modems. Other computers, termed “clients” or “workstations,” provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are possible.

The system 100 comprises one or more software programs. The system 100 may comprise software configured to download data, to merge data from other origin databases, and to enable users to manually add and modify data. The system 100 may also comprise one or more databases for storing, retrieving, organizing, and, generally, for managing data. Data may include general data and patient data. In healthcare data management, the term “patient” refers to a person whose medical information is stored in the system 100. As used herein, patient data refers to data that can identify a patient including administrative data such as name, address, phone number, and medical data such as physiological parameter values including without limitation blood glucose values, A1c values, Albumin values, Albumin excretion values, body mass index values, blood pressure values, carbohydrate values, cholesterol values (total, HDL, LDL, ratio) creatinine values, fructosamine values, HbA1 values, height values, insulin dose values, insulin rate values, total daily insulin values, ketone values, microalbumin values, proteinuria values, heart rate values, temperature values, triglyceride values, and weight values. Patient data may be provided by the patient, a healthcare professional, a medical device, a caregiver, or anyone having relevant data pertaining to a patient. In one embodiment, the databases are relational databases and the database server is the MICROSOFT SQL Server Express 2005. Computer 100 may include other applications required for operation of the SQL Server.

The system 100 is configured to provide medical data to, and receive data from, the medical device 120. In FIG. 1, the computing device 102 includes communication media 116, in this case a modulated signal transceiver, in logical communication with the processor and software applications by means of a cable 114, and configured to transmit and receive a modulated signal 122 to establish logical communication with the medical device 120. The communication media is typically embodied by computer-readable instructions, data structures, program modules or other data in a modulated data signal such as a carrier wave or other transport mechanism and includes any information delivery media. The term “modulated data signal” means a signal that has one or more of its characteristics set or changed in such a manner to encode information in the signal. By way of example, and not limitation, communication media includes wired media such as a wired network or direct wired connection, and wireless media such as acoustic, RF, infrared and other wireless media. Combinations of any of the above are included within the scope of computer-readable media.

Medical devices are devices capable of recording patient data and transferring data to software applications. They may include monitors which record values of measurements relating to a patient's physiological condition and information such as the time and date when the measurement was recorded. Medical devices may also be devices configured to provide medications to patients such as, for example, insulin pumps. These devices, generally, record dosage amounts as well as the time and date when the medication was provided. Optionally, medical devices may have their own user input devices and display devices. A medical device may also comprise a computing device integrated or coupled with a device for recording medical data including without limitation a computer, a personal digital assistant (PDA), a phone, a BLACKBERRY. Furthermore, the system 100 may be integrated with the medical device 120 thereby eliminating the necessity of generating and transmitting a modulated signal.

A medical device is, generally, assigned to a patient and associated with that patient in the system 100. Thus, when medical data from the medical device is transferred to the system 100, the medical data from the medical device automatically populates database records relating to that patient.

The system 100 is configured to display information in a plurality of forms and formats. While the screen display has been explained in detail with reference to a display device comprising a video screen for convenience, the term screen display is not intended to be so limiting. The screen display may be displayed in any output device capable of displaying mapped images of any kind. Thus, information may be shown by outputting a screen display onto, for example, a video screen, projecting it from a video projector, and by printing the screen display on a printer. The screen display may also be communicated via e-mail or fax.

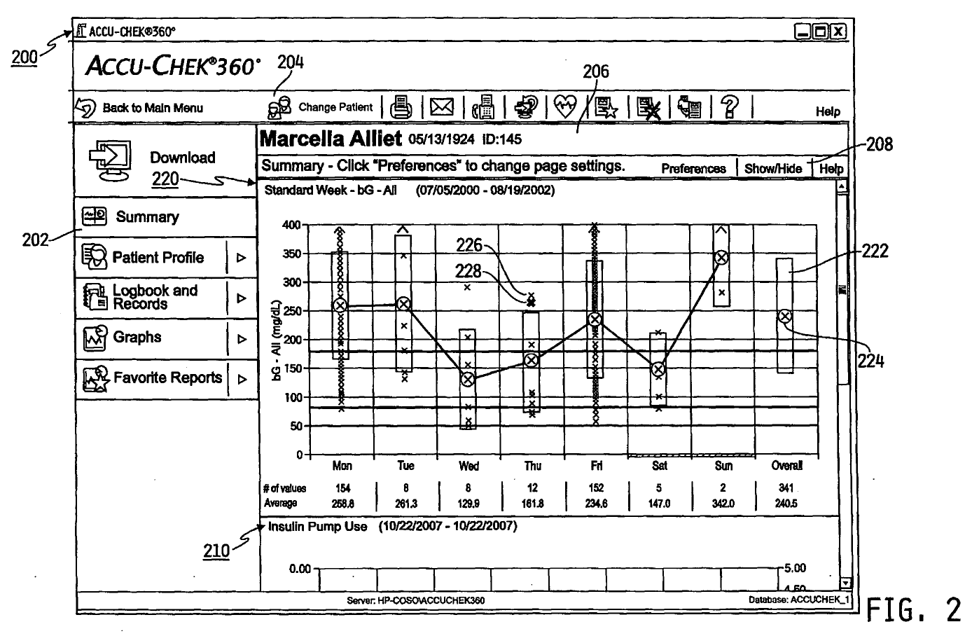

FIG. 2 depicts an exemplary embodiment of a system 100 according to the invention for displaying information. A screen display 200 exhibits the first aspect of the method according to the invention. The screen display 200 shows a summary view of a patient's data comprising a primary menu 202 having display objects representing menu items titled summary, patient profile, logbooks and records, graphs, and favorite reports; a secondary menu 204 having display objects representing a plurality of functions such as change patient, print (icon depicting a printer), e-mail (icon depicting an envelope), etc.; a patient identification area 206 for displaying patient identification data; an options bar 208 for changing the display options; a first graph 220 labeled “Standard Week—bG—All” for displaying medical data, and a partial view of a second graph 210 labeled “Insulin Pump Use.”

Blood glucose, abbreviated bG, is an important physiological parameter for diabetic patients. It is a measurement of glucose or sugar levels in the patient's blood. Blood glucose levels are measured regularly and frequently using a type of medical device such as a glucose meter. Patients control blood sugar levels through medication, diet, physical activity, and other behaviors. The system 100 receives medical data, including bG data, pertaining to these variables may display the data in statistical, tabular, or other forms to ease interpretation. Similarly, the software may receive medical data pertaining to any of a plurality of physiological conditions of the patients and related medical devices. The standard week bG graph 220 shows a statistical representation of medical data of glucose levels for time periods corresponding to days of the week and overall. For each time period, the graph 220 shows bars 222 representing the variation in blood glucose levels, mean markers 224, each depicted as an X inside a circle, and outliers including outlier marker 226 and group marker 228 representing a group of outliers. The graph 220 provides the user an overview of the patient's glucose levels during various timeframes.

In accordance with an aspect of the present invention, a method for displaying information in a screen display presented on the display device is provided. The method may be implemented in the computing device of the invention. In accordance with the method, a software application displays a screen display comprising at least one group display object. Group display objects include group markers, merged tooltips, and interactive tooltips.

In one embodiment of the method for displaying information, a software application provides data points for locating point display objects on a screen display and provides at least one group display object representative of a group of near points and distinguishable from a point display object. As used herein, near points are data points whose screen display representations overlap so as to hinder interpretation of the data. What constitutes “near” is relative and is influenced by the configuration of the system 100, the input of a user, or the subjective quality or “look and feel” of the system.

In one embodiment, near points are identified by the amount of overlap of their corresponding screen display images. An application may map the images to the screen display to determine the amount of overlap by, for example, calculating the percentage of pixels of each image written to the same screen display location. In this embodiment, two points are near when their images on a screen display overlap by more than a “near” amount. The near amount may be a number of pixels or a percentage of an image space. Near points may thus be determined by a percentage representative of an amount of overlap subjectively determined to be “near.”

In a preferred embodiment according to the invention, the near amount is 15%, more preferably 30%, and even more preferrably 50%.

In another embodiment, near points are identified by the distance between their placement control points. An application may compare the distance between data points to a near distance to identify groups of near points. In this embodiment, two points are near when their values or the distance between them on a screen display is less than a “near” distance. Thus described, a near distance is a measure of a distance or separation measured in pixels, or a difference in values corresponding the pixel distance once the values are mapped to the screen display to determine the location of the placement control points of the display images. The near distance may be predefined or determined interactively. Near points may thus be determined by a distance subjectively determined to be “near.”

In an alternative embodiment, the near distance may be determined interactively to change the “look and feel” of the screen display. The near distance may be determined interactively by receiving from the user input corresponding to a desired near distance. The user may provide a near distance value in many ways including a number scaled in pixels or a different unit of measure, or a scaled value provided by selection from a graphically displayed scale.

In another embodiment, a user interactively selects a group of near points using a user input device to mark an area of the screen 108. The points within the marked area are thus identified as near points. An application may select a near distance based on the selection and then apply the calculated near distance to identify additional groups of near points. The near distance may be calculated as the maximum distance between any two points in the marked area, or the average distance between all the points in the marked area, or by some other calculation including without limitation calculations based on statistical analysis of the points in the marked area.

The distance between two display objects may be the distance between the position attribute of each object. The position attribute contains the coordinates of the screen display where the display object is to be located. The display object is located on the screen display by placing the location control at the position attribute. The placement control might be a center point, a corner, or any other control point on the display object. Data points or values to be plotted in a graph are represented in a screen display by display objects. Display objects associated with near points are near display objects.

In a preferred embodiment according to the invention, the near distance is between 0.9 and 6.1 pixels, more preferably between 1.4 and 4.6 pixels, and even more preferrably between 1.9 and 3.1 pixels.

In another embodiment according to the invention, the near distance comprises the difference in the values of the data points, the difference corresponding to between 0.9 and 6.1 pixels, more preferably between 1.4 and 4.6 pixels, and even more preferrably between 1.9 and 3.1 pixels.

The distance between points may be calculated in different ways. In one embodiment, the distance is calculated by the square root method where distance is equal to the square root of the sum of the square of the absolute x-axis distance between the points and the square of the absolute y-axis distance between the points. By absolute distance it is meant the difference between two distances along the same axis. If the points are vertically aligned, the distance is the absolute y-axis distance between them and if the points are horizontally aligned, the distance is the absolute x-axis distance between them. In another method, distance is calculated applying vector analysis.

A database may contain values to be plotted in a series on a graph relating to data variables and their characteristics, e.g., name, value, time, date, and so forth. The system 100 may be designed to display standard screen displays or may be designed to create screen displays interactively. Forms may be used to predefine graph characteristics such as X-Y axis dimensions, graph title, axis title, and so on. In one embodiment, the user may select the type of graph, variables to be plotted, a subset of the available values based on a range of dates or other criteria, and so on. In another, the user may only chose a date range for displaying data values in series. Alternatively or additionally, a user may select some or all characteristics of a graph interactively. A graph may display more than one series.

The design of the graph determines the variables and range of values to be plotted. A software application compares the data values to identify near points. The application converts either the values, or the near distance, so that they are on the same scale, which could be the physical unit of measure scale of the values, e.g., mL, mg, mm, or a pixel scale. In a preferred embodiment, the application converts the data values from their physical values to a pixel scale before carrying out the comparison.

Data points may be associated to display objects in an array where each row in the array corresponds to a data point to be plotted. The array may contain the value of the data point, position attribute values, a reference to the display image associated with it, and other data related to it such as tooltips. In the case of graphs to display statistical results, the value of the data point may be a data value, a statistic, or other type of value. The display image may be an image associated with a data value, or may be an image associated with a statistic, e.g., a bar to represent variation in a range of data values, a circle to represent the average of a range of data values, an X to represent an outlier data value, and so on. Display objects that represent individual values may be point markers or unmerged tooltips, irrespective of whether the value is a data value or a statistic. Point markers may represent points which are near points and also points that are not near points. Alternatively, near points may be represented by group markers. Display objects corresponding to near points are near display objects regardless of whether they are point or group display objects.

In one embodiment, the points are ordered along either the X or Y axis before the comparison. Each point is compared to the next point in the order. If the pair are near, they are near points, and a group display object will represent both points on the screen display. Group markers are visually distinguishable from point markers. No display object is displayed to represent the second point except as otherwise already stated. The next comparison is made between the first point and the next point in the order. If a near point results, the comparisons continue until the “next point” is not near the first point. At that time, all the near points identified form the entire group, and the “next point” in the order becomes the “first point” in a new set of comparisons designed to identify additional groups.

In one embodiment, the group marker is made distinguishable from a point marker by changing one or more characteristics of the point image. Characteristics include color, shape, texture, emphasis, size, shade and style and so on. For example, a point marker x is distinguished from a group marker X and from a group marker x. In another embodiment, the group marker may have the shape of a number. For example, the group marker 5 may be used to denote that five data points are represented by the group marker.

The above mentioned algorithm may present a slightly skewed picture of the data to the user because group images are located in the locations of the earlier ordered points in any group rather than in a location that may better represent the center of the group. In one embodiment, this skewing effect is corrected by centering the group image. Centering may be accomplished by adding to the array group points whose X-Y coordinates are the average locations for the points in the group. All of the display images of the points in each group are removed, and a group image is associated with each of the group points.

The above mentioned algorithm may, due to the ordering and sequential comparison, arbitrarily include a point within a group when that point may be nearer a following group. The above mentioned algorithm may be modified to create more or less sophisticated comparison algorithms to redistribute points between groups. One such algorithm may perform a secondary comparison between points in groups and other groups located nearby to determine whether some points should be moved from group to another based on the distance from the points to the group points. Such added complexity may be unnecessary in some contexts depending on the system 100 characteristics, the nature of the data to be displayed, and the message to be communicated to the user. In some contexts, as further described below, redistributing points to present a more accurate picture to the user may be desirable.

In accordance with another aspect of the present invention, a method for displaying information in a screen display presented on the display device is provided. The data set underlying the screen display has near points comprising groups which may be represented by near point markers or by group markers. Upon activation of a near display object, which may be a group marker or a point marker, a software application displays a merged tooltip. A merged tooltip is a tooltip that combines the tooltips of some or all of the near points which comprise a group. The merged tooltip, when displayed in response to activation of a point marker, is particularly useful to provide information relating to a cluster of points.

In one embodiment, the software application creates the merged tooltip upon activation of the near display object. In another embodiment, the software application creates the merged tooltip at the time it creates a group point, and associates the merged tooltip with the group point. In the latter case, the merged tooltip is displayed upon activation of the group display object. The tooltip may be displayed proximally to the activated display object.

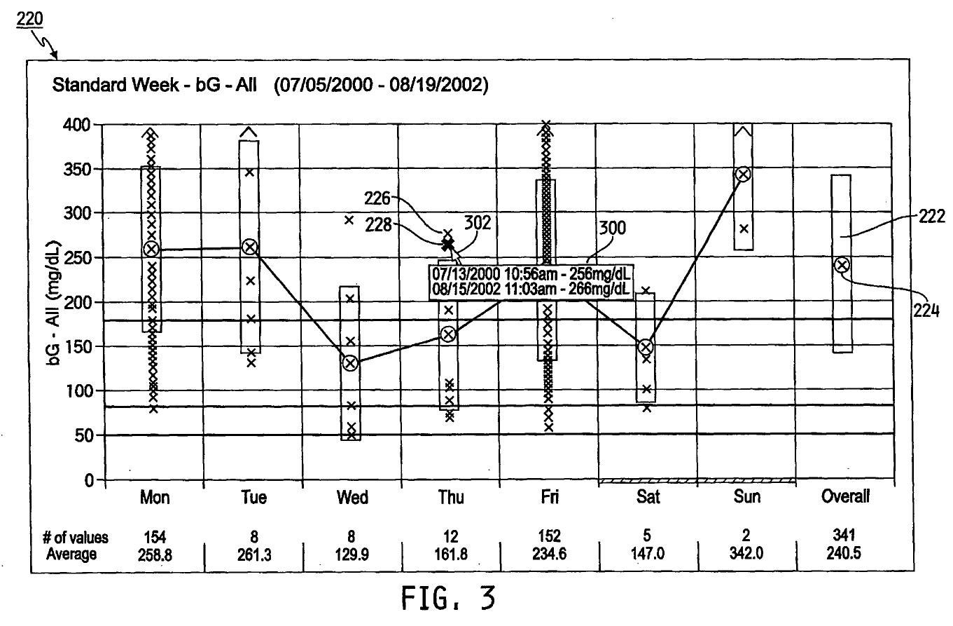

Furthermore, a method for displaying information in a screen display which combines the first and second aspects of the invention is provided. FIG. 3 shows a graph portion of a screen display according to the invention depicting display objects including point markers, group markers, and a merged tooltip. The display objects in graph 220 are the same as were discussed with reference to FIG. 2 and will not be described again. FIG. 3 also displays a merged tooltip 300 located proximally to a screen pointer 302. The screen pointer 302 is shown hovering over the group marker 228. The merged tooltip 300 displays tooltips corresponding to the two near points that comprise the group represented by the group marker 228. A data value, 265 mg/dL, was obtained on Jul. 13, 2000 at 10:56 am, and the other data value, 266 mg/dL, was obtained on Aug. 15, 2000 at 11:03 am. The data values and related information are fictitious. Thus, FIG. 3 shows the display of at least two group display images: group markers and merged tooltips.

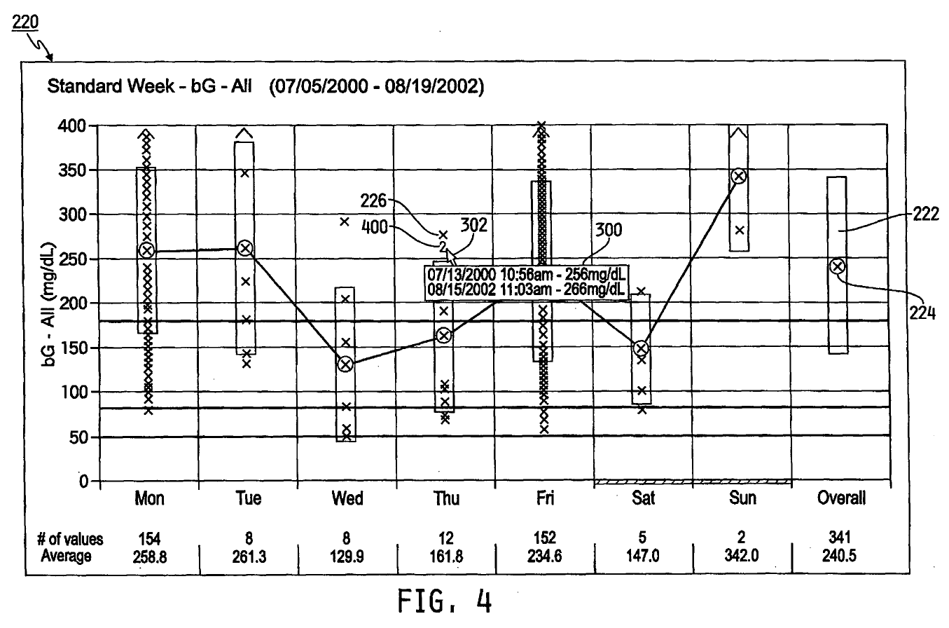

FIG. 4 shows a graph portion of a screen display according to the invention depicting display objects including point markers, group markers, and a merged tooltip 300. The display objects in graph 220 are the same as were discussed with reference to FIG. 2 and will not be described again. FIG. 4 also shows a group marker 400 in the shape of a number two depicting the number of near points in the group represented by the group marker.

In accordance with a further aspect of the present invention, a method for displaying information in a screen display presented on the display device is provided. A software application displays an interactive tooltip. An interactive tooltip is a tooltip that may be activated. Upon activation, the interactive tooltip may provide user options for further displaying of display objects or for other purposes described more fully below. In one embodiment, the interactive tooltip is an object that may be activated. In another, the interactive tooltip contains at least one activatable content object.

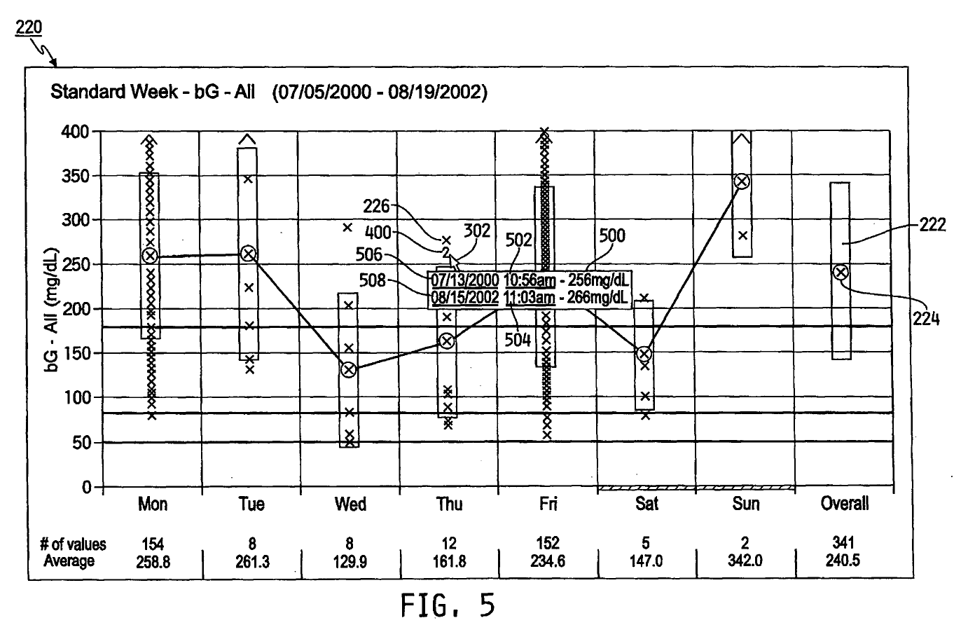

FIG. 5 shows a graph portion of a screen display according to the invention depicting display objects including point markers, group markers, and an interactive tooltip 500 having content objects. A content object represents at least a portion of data relating to a display object. The content objects of the interactive tooltip 500 include content objects 502, 504, 506, 508 associated with the time of the first result, the time of the second result, the date of the first result, and the date of the second result, respectively. Upon activation of a content object, a software application displays an option menu and performs a function according to the option selected by the user. For example, one option may be to display additional tooltips relating to the data category of the activated content object. Activation of the content object showing the date of a measurement may cause the display of a menu where one choice is to display tooltips (or highlight all data) for all points obtained on that date. Another option may be to remove from the screen display objects relating to the data category of the activated content object. For example, activation of a content object showing the time of a measurement may cause the display of a menu where one choice is to remove from the screen display all points obtained during a time range around the time of the selected time value. Because there are nearly unlimited choices of content to display, there are many types of content that may be used to generate an interactive tooltip. In addition to the date and time of a measurement, a content object may relate to a specific event, such as the ingestion of type of meal, or to the number of near points in a group, and many more.

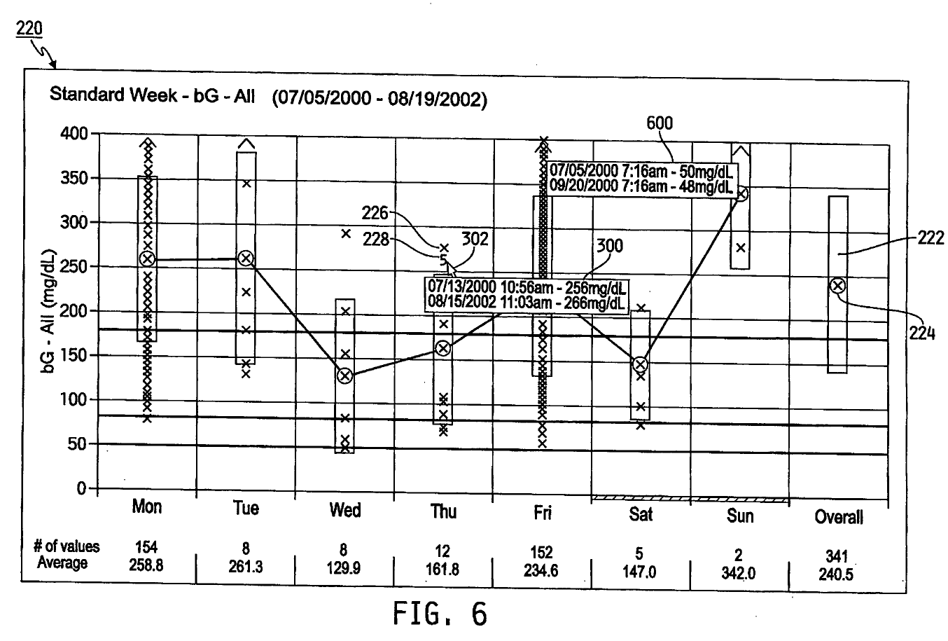

In accordance with a further aspect of the present invention, a method for displaying information in a screen display presented on the display device is provided. A software application displays multiple tooltips on the same screen display in accordance with user commands. FIG. 6 shows a graph portion of a screen display according to the invention depicting display objects including point markers, group markers, and merged tooltips 300, 600. To display multiple tooltips, the user commands the system 100 to continue displaying the first tooltip displayed, and then commands the system 100 to display additional tooltips. Finally, the user may command the system 100 to remove tooltips from the display, individually or altogether.

The user may activate a display object by hovering to cause the display of a tooltip. While the tooltip is displayed, the user may command the system 100 to continue displaying the tooltip after the screen pointer is moved. The user may command the system 100 using any user input device control. In one embodiment, the user provides a single input, for instance by clicking the right mouse button, to command the system to display the tooltip after the screen pointer is moved. The user may move the screen pointer and mouseover or hover over another display object to cause another tooltip to appear. The process of displaying tooltips may be repeated.

In another embodiment, after the user commanded the continuing display of a first tooltip, the user may select an area of the screen display with the user input device, and then command the system to display all tooltips within the selected area.

Once the user no longer wishes to see the tooltips, the user may command the system to remove them from the screen display. In one embodiment, the user may command the system to remove them from the screen display by providing a single input. In another embodiment, the user may provide a command to remove a single tooltip. In yet another embodiment, the user may select an area of the screen display with the user input device, and then command the system to remove all tooltips within the selected area.

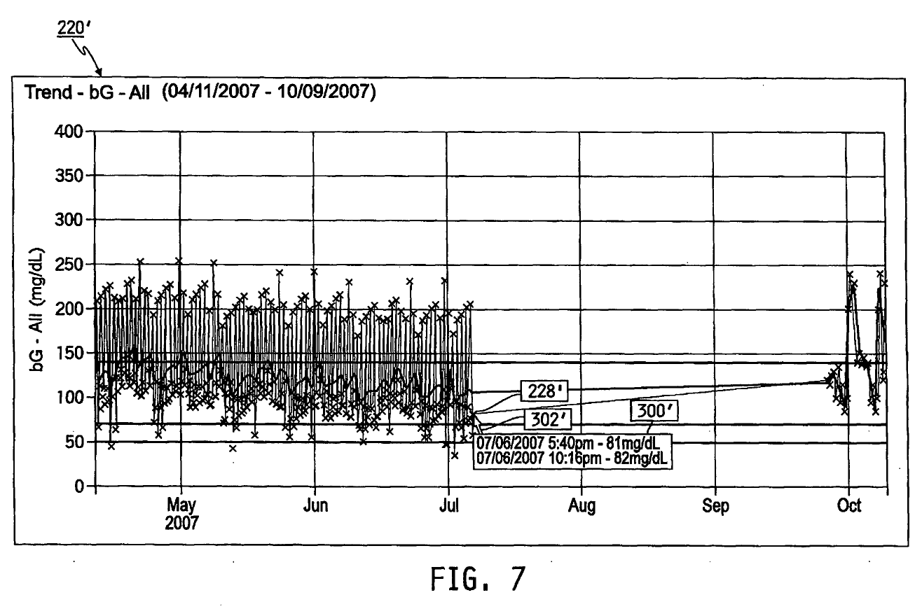

FIG. 7 depicts another graph according to the invention. The graph 220′ is a scatter-graph labeled “Trend—bG—All (Apr. 11, 2007-Oct. 9, 2007)” depicting bG data during the given time range. A group marker 228′ is shown in boldface and is larger than the surrounding point markers. The cursor 302 is shown near the group marker 228′. The cursor 302′ hovered sufficiently to cause tooltip 300′ to appear.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method for displaying information on an output device comprising the steps of:
providing point display objects representing data points to a screen display; and
providing at least one group display object representing a group of near points to the screen display, wherein the at least one group display object is distinguishable from point display objects.

2. The method of claim 1 wherein near points are data points whose screen display representations overlap so as to hinder interpretation of the data.

3. The method of claim 1 further including the step of comparing the distance between data points to a near distance to identify groups of near points.

4. The method of claim 3 wherein the identification of near points is based on comparison to a predefined near distance.

5. The method of claim 4 wherein near points comprise data points having values which differ by an amount corresponding to between 0.9 and 6.1 pixels.

6. The method of claim 4 wherein the data points have corresponding point locations on the screen display and near points are identified by comparing point locations.

7. The method of claim 6 wherein near points comprise data points having point locations which are separated by a near distance between 0.9 and 6.1 pixels.

8. The method of claim 3 further including the step of interactively selecting a near distance, wherein the identification of near points is based on comparison to the near distance.

9. The method of claim 1 further including the step of interactively selecting at least one group of near points.

10. The method of claim 1 further including the step of comparing the amount of overlap between data point display objects to a near amount to identify groups of near points.

11. The method of claim 10 wherein the near amount is 20%.

12. The method of claim 1 wherein the at least one group display object is a group marker and the point display objects are point markers.

13. The method of claim 12 wherein the point markers and the at least one group marker are distinguishable based upon at least one characteristic from the group consisting of color, shape, texture, emphasis, size, shade and style.

14. The method of claim 12 wherein the group marker is shaped as a number and the point marker is not shaped as a number.

15. The method of claim 1 wherein the at least one group display object is a merged tooltip.

16. The method of claim 1 wherein the at least one group display object is an interactive tooltip.

17. The method of claim 16 further including the step of providing user options upon activation of the interactive tooltip.

18. The method of claim 1 where the at least one group display object is not a tooltip, further including the step of providing at least one tooltip selected from the group consisting of an unmerged tooltip, a merged tooltip, and an interactive tooltip.

19. A method for displaying information on an output device comprising the steps of:
providing data points for locating point display objects on a screen display;
selecting a subset of the data points; and
providing tooltips corresponding to the selected data points.

20. A system for displaying data comprising:
a computing device having an output device for outputting a screen display and software configured to:
provide data points for locating point display objects on the screen display;
compare data points to identify groups of near points; and
provide at least one group display object representing a group of near points to the screen display, wherein the at least one group display object is distinguishable from point display objects.

21. The system of claim 20 wherein the output device is a display device.

22. The system of claim 20 wherein the output device is a printing device.
